(19) United States
(12) Patent Application Publication
(10) Pub. No.: US 2025/0276428 A1
(43) Pub. Date: Sep. 4, 2025

(54) ELECTRIC TOOL

(71) Applicant: PANASONIC HOLDINGS CORPORATION, Osaka (JP)

(72) Inventors: Masamichi NAKAMURA, Shiga (JP); Keita OKAMOTO, Mie (JP); Nobuyori SAKAI, Mie (JP)

(21) Appl. No.: 18/858,661

(22) PCT Filed: Apr. 10, 2023
(86) PCT No.: PCT/JP2023/014521

§ 371 Date: Oct. 21, 2024

(30) Foreign Application Priority Data
Apr. 27, 2022 (JP) 2022-073603

(51) Int. Cl. B25B 21/00; B25F 5/02

(52) U.S. Cl. CPC B25B 21/00; B25F 5/02

(57) ABSTRACT

An electric tool includes a motor, a switch unit, a housing, an operating member, and an interlocking member. The motor rotates a tip tool. The switch unit selectively provides or cuts off supply of power to the motor. The housing houses the motor. The operating member is provided outside the housing and is displaced between a first position and a second position in response to an operation. The interlocking member is displaced between a third position and a fourth position in response to displacement of the operating member. The housing is arranged to house the switch unit. The switch unit cuts off the supply of the power to the motor when the interlocking member is located at the third position and provides the supply of the power to the motor when the interlocking member is located at the fourth position.

### TECHNICAL FIELD

The present disclosure generally relates to an electric tool, and more particularly relates to an electric tool including a motor.

### BACKGROUND ART

Patent Literature 1 discloses an electric rotary tool designed to be operated with a lever. The electric rotary tool of Patent Literature 1 includes a switch lever provided for a part of the casing of its grip and a magnetic sensor. The magnetic sensor is arranged to face a magnet provided for a displaceable portion of the switch lever. The magnetic sensor is connected to an energizing circuit of an electric motor.

The electric rotary tool of Patent Literature 1 is configured to start driving the electric motor by turning ON the energizing circuit in response to the detection of magnetism by the magnetic sensor.

### CITATION LIST

### Patent Literature

Patent Literature 1: JP 2002-254346 A

### Summary of Invention

In the electric rotary tool (electric tool) of Patent Literature 1, the magnetic sensor may go out of order when impact is applied to the magnetic sensor exposed out of the grip casing (housing).

In view of the foregoing background, it is therefore an object of the present disclosure to provide an electric tool which may reduce the chances of a constituent member thereof, such as a switch, going out of order.

An electric tool according to an aspect of the present disclosure includes a motor, a switch unit, a housing, an operating member, and an interlocking member. The motor rotates a tip tool. The switch unit selectively provides or cuts off supply of power to the motor. The housing houses the motor. The operating member is provided outside the housing and is displaced between a first position and a second position in response to an operation. The interlocking member is displaced between a third position and a fourth position in response to displacement of the operating member. The housing is arranged to house the switch unit. The switch unit cuts off the supply of the power to the motor when the interlocking member is located at the third position and provides the supply of the power to the motor when the interlocking member is located at the fourth position.

### BRIEF DESCRIPTION OF DRAWINGS

FIG. 1 is a front view of an electric tool according to a first embodiment:

FIG. 2 is an exploded perspective view of a main part of the electric tool:

FIG. 3 is a cross-sectional view illustrating one state of the electric tool:

FIG. 4 is a cross-sectional view illustrating another state of the electric tool:

FIG. 5 is a cross-sectional view illustrating one state of an electric tool according to a second embodiment: and

FIG. 6 is a cross-sectional view illustrating another state of the electric tool.

### DESCRIPTION OF EMBODIMENTS

Preferred embodiments of the present disclosure will now be described in detail with reference to the accompanying drawings. In the following description of embodiments, any pair of constituent elements, shown in multiple drawings and having the same or substantially the same function, will be designated by the same reference numeral and description thereof will be omitted herein to avoid redundancy. Note that the embodiments to be described below are only exemplary ones of various embodiments of the present disclosure and should not be construed as limiting. Rather, the exemplary embodiments may be readily modified in various manners depending on a design choice or any other factor without departing from the scope of the present disclosure. The drawings to be referred to in the following description of embodiments are all schematic representations. Thus, the ratio of the dimensions (including thicknesses) of respective constituent elements illustrated on the drawings does not always reflect their actual dimensional ratio. On the accompanying drawings, arrows indicating respective directions are only exemplary ones and should not be construed as limiting the directions in which the electric tool 1 is supposed to be used. In addition, on the drawings, those arrows indicating the respective directions are shown there for illustrative purposes only and are all insubstantial ones.

As used herein, if two things “are perpendicular to each other (or cross each other at right angles),” this expression refers to not only a situation where the angle formed between the two things is exactly 90 degrees but also a situation where the difference of the angle formed between the two things from 90 degrees falls within a certain tolerance range. That is to say, the angle formed between the two things that are perpendicular to each other falls within the range of 90degrees plus some tolerance (of 10 degrees or less, for example). That is to say, the phrase “perpendicular to” as used herein refers to a situation where the angle formed between the two things is equal to or greater than 80 degrees and equal to or less than 100 degrees. Note that if something is “parallel to” something else, this phrase refers to not only a situation where these two things never intersect with each other in a strict sense of the word but also a situation where these two things intersect with each other within a range with a certain difference. For example, the phrase “parallel to” as used herein also refers to a situation where the tilt angle defined by one things with respect to the other is equal to or less than 10 degrees. That is to say, the phrase “parallel to” as used herein may also refer to a situation where the angle formed between one thing and the other thing is equal to or greater than −10 degrees and equal to or less than 10 degrees.

Furthermore, in the following description of embodiments, if one of two values such as distances being compared with each other is “equal to or less than” the other, this phrase may also be a synonym of the phrase “less than.” That is to say, it is arbitrarily changeable, depending on selection of a preset value, whether or not the phrase “equal to or less than” covers the situation where the two values being compared with each other are equal to each other. Therefore, from a technical point of view, there is no difference between the phrase “equal to or less than” and the phrase “less than.” Similarly, the phrase “equal to or greater than” may be a synonym of the phrase “greater than” as well.

### First Embodiment

### (1) Overview

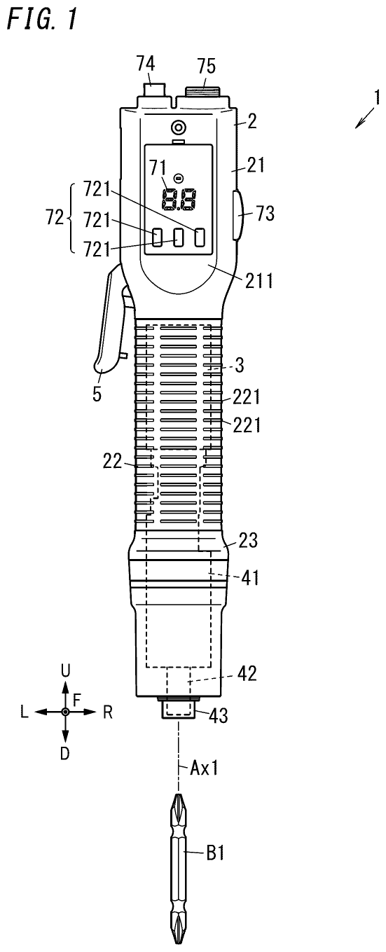

First, an overview of an electric tool 1 according to a first embodiment will be described with reference to FIGS. 1-4.

As shown in FIG. 1, the electric tool 1 according to the first embodiment is designed to allow the worker (user), for example, to grip the electric tool 1 with only one of his or her hands. A tip tool B1 such as a screwdriver bit is attachable to the electric tool 1 according to the first embodiment.

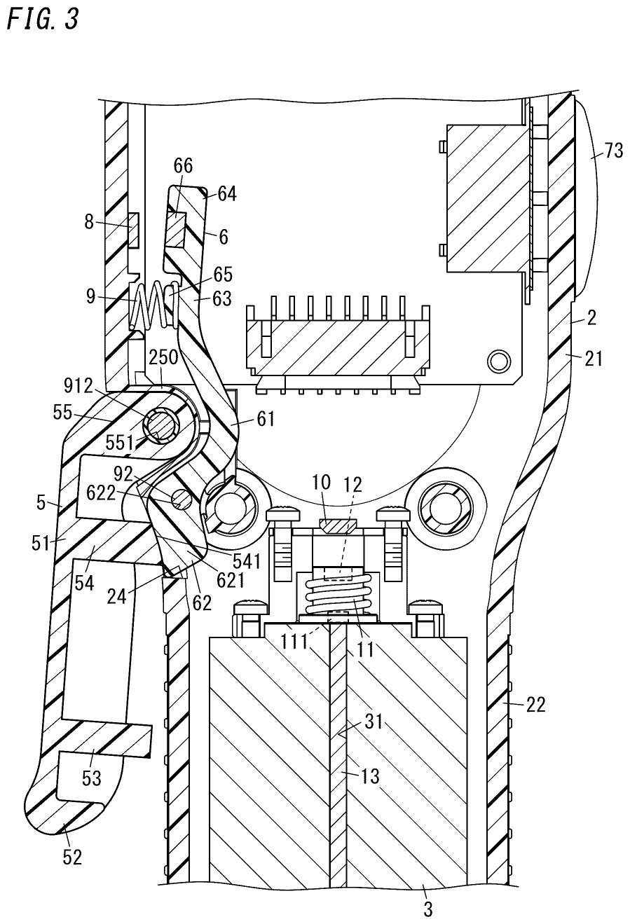

The electric tool 1 according to the first embodiment includes a housing 2, a motor 3, an operating member 5, an interlocking member 6 (refer to FIG. 3), and a first switch unit 8 (refer to FIG. 3).

The motor 3 rotates the tip tool B1.

The housing 2 houses the motor 3 and the first switch unit 8.

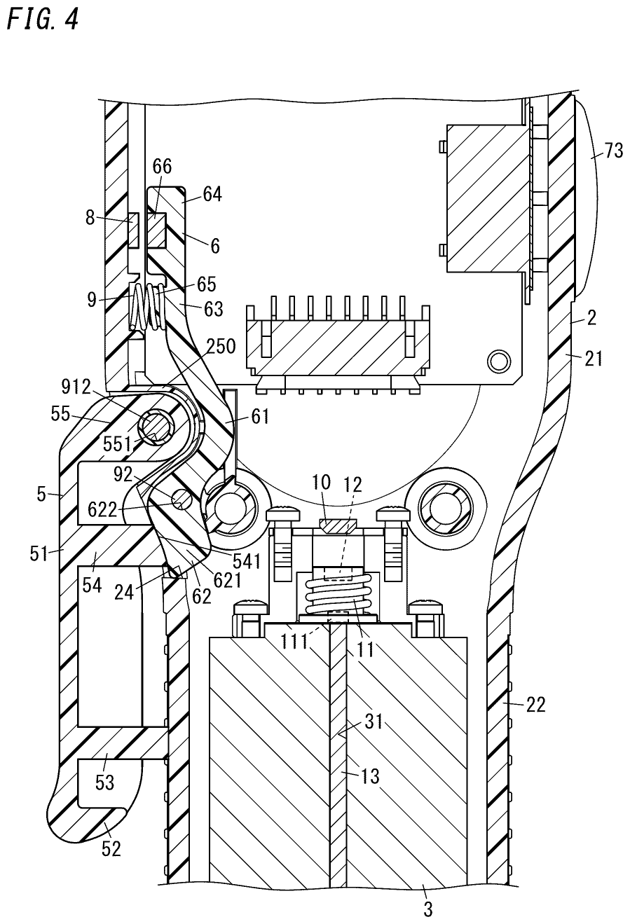

The operating member 5 is provided outside the housing 2. The operating member 5 is displaced between a first position (refer to FIG. 3) and a second position (refer to FIG. 4) in response to an operation performed by the user.

As used herein, the “first position” may refer to the position of the operating member 5 in a situation where the operating member 5 is not subjected to a press operation by the user and the position of the operating member 5 where the supply of power to the motor 3 is cut off. On the other hand, the “second position” as used herein may refer to the position of the operating member 5 in a situation where the operating member 5 is subjected to the press operation by the user and the position of the operating member 5 where the supply of power to the motor 3 is provided.

As shown in FIGS. 3 and 4, the interlocking member 6 is at least partially housed inside the housing 2. The interlocking member 6 is displaced, as the operating member 5 is displaced, between a third position (refer to FIG. 3) and a fourth position (refer to FIG. 4).

As used herein, the “third position” refers to the position of the interlocking member 6 when the operating member 5 is located at the first position and the position of the interlocking member 6 in a situation where the supply of power to the motor 3 is cut off. On the other hand, the “fourth position” as used herein refers to the position of the interlocking member 6 when the operating member 5 is located at the second position and the position of the interlocking member 6 in a situation where the supply of power to the motor 3 is provided.

The first switch unit 8 selectively provides or cuts off the supply of power from an external power supply to the motor 3. The first switch unit 8 cuts off, when the interlocking member 6 is located at the third position, the supply of the power to the motor 3. On the other hand, when the interlocking member 6 is located at the fourth position, the first switch unit 8 provides the supply of the power to the motor 3.

In the electric tool 1 according to the first embodiment, the first switch unit 8 is provided inside the housing 2, thus reducing the chances of impact being applied to the first switch unit 8 compared to a situation where the first switch unit 8 is exposed outside the housing 2. Consequently, the electric tool 1 according to the first embodiment may reduce the chances of a constituent member such as a magnetic sensor of the first switch unit 8 going out of order.

### (2) Details

Next, a detailed configuration for the electric tool 1 according to the first embodiment will be described with reference to FIGS. 1-4.

### (2.1) Electric Tool

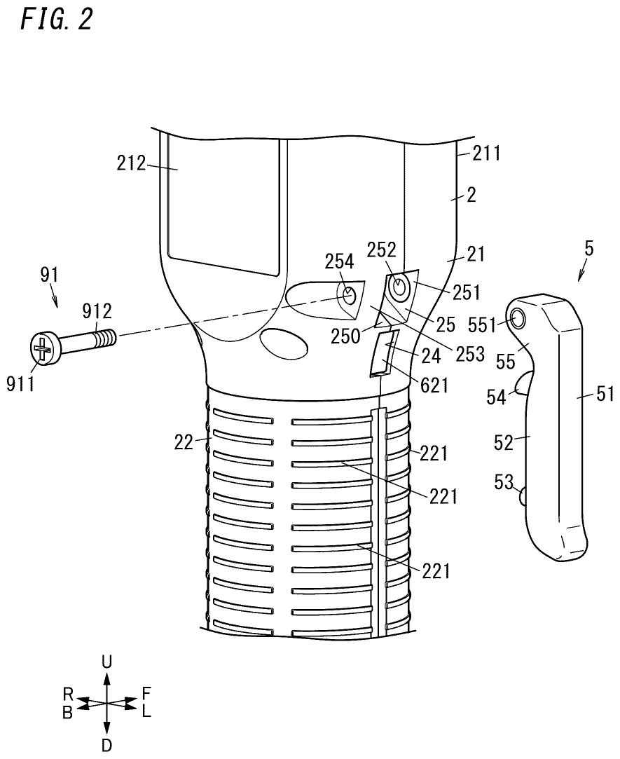

As shown in FIG. 1, the electric tool 1 includes the housing 2, the motor 3, a transmission mechanism 41, an output shaft 42, a holder 43, the operating member 5, the interlocking member 6 (refer to FIG. 3), a display unit 71, an operating unit 72, a forward/reverse switch 73, a signal connector 74, a power connector 75, the first switch unit 8 (refer to FIG. 3), an elastic member 9 (refer to FIG. 3), a coupling shaft 91 (refer to FIG. 2), and a second switch unit 10 (refer to FIG. 3). In the first embodiment, the tip tool B1 is counted out of the constituent elements of the electric tool 1. However, this is only an example and should not be construed as limiting. Alternatively, the tip tool B1 may also be one of the constituent elements of the electric tool 1.

Note that in the following description, the direction parallel to the center axis Ax1 of the output shaft 42 is defined to be an “upward/downward direction.” Specifically, the direction pointing from the output shaft 42 toward the motor 3 is herein defined to be an “upward direction” and the direction pointing from the motor 3 toward the output shaft 42 is herein defined to be a “downward direction.”

### (2.2) Housing

As shown in FIG. 1, the housing 2 is formed in the shape of a cylinder extending in the upward/downward direction. Note that a “cylindrical shape” as used herein refers to a circular cylindrical shape, an elliptic cylindrical shape, or a square tubular shape.

The housing 2 according to the first embodiment houses the motor 3, the transmission mechanism 41, at least a part of the output shaft 42, at least a part of the interlocking member 6 (refer to FIG. 3), the first switch unit 8 (refer to FIG. 3), the elastic member 9 (refer to FIG. 3), and the second switch unit 10 (refer to FIG. 3).

The housing 2 according to the first embodiment has a first body part 21, a second body part 22, a third body part 23, a through hole 24 (refer to FIG. 2), and a recess 25 (refer to FIG. 2).

The first body part 21 is formed in the shape of a square tube with an upper surface. The lower surface of the first body part 21 is a circular opening. As shown in FIG. 3, the first body part 21 according to the first embodiment houses at least a part of the interlocking member 6, the first switch unit 8, the elastic member 9, and the second switch unit 10.

As shown in FIG. 2, the first body part 21 has a first surface 211 and a second surface 212. The first surface 211 and the second surface 212 are parallel to each other.

In this description, a direction in which the first surface 211 and the second surface 212 are arranged side by side is herein defined to be a “forward/backward direction.” Specifically, the direction pointing from the second surface 212 toward the first surface 211 is herein defined to be a “forward direction” and the direction pointing from the first surface 211 toward the second surface 212 is herein defined to be a “backward direction.” The forward/backward direction is perpendicular to the upward/downward direction. Furthermore, a direction perpendicular to both the upward/downward direction and the forward/backward direction is herein defined to be a “rightward/leftward direction.” In other words, the forward/backward direction and the rightward/leftward direction are radial directions of a virtual circle, of which the center is defined by the center axis Ax1 of the output shaft 42.

The first body part 21 according to the first embodiment has the through hole 24 and the recess 25.

The through hole 24 according to the first embodiment is provided at an end portion of the first body part 21 in the rightward/leftward direction. The through hole 24 is provided to face the operating member 5 in the rightward/leftward direction. The through hole 24 penetrates through the first body part 21 along the thickness of the first body part 21. In side view (i.e., when viewed in the rightward/leftward direction), the through hole 24 has a rectangular shape.

The recess 25 according to the first embodiment is provided at the end portion of the first body part 21 in the rightward/leftward direction and above the through hole 24. The recess 25 is depressed toward the inside of the first body part 21. In side view, the recess 25 has a rectangular shape.

The recess 25 according to the first embodiment has a bottom wall 250, a front wall 251, and a rear wall 253. The bottom wall 250 is formed in the shape of U-curve plate which is convex toward the inside of the housing 2. In the forward/backward direction, the front wall 251 and the rear wall 253 face each other.

The front wall 251 is located forward of the rear wall 253 with a gap left between themselves. The front wall 251 has a hole 252. The hole 252 is depressed forward. In front view, the hole 252 has a circular shape. The hole 252 has a thread on an inner circumferential surface thereof. That is to say, the hole 252 is a screw hole. A front end of a shaft portion 912 (to be described later) of the coupling shaft 91 is screwed into the hole 252.

The rear wall 253 has a through hole 254. The through hole 254 penetrates through the rear wall 253 in the forward/backward direction. In front view, the through hole 254 has a circular shape. In front view, the through hole 254 and the hole 252 are aligned with each other. The shaft portion 912 of the coupling shaft 91 is passed through the through hole 254.

As shown in FIG. 1, the second body part 22 protrudes downward from the lower end of the first body part 21. The second body part 22 is formed in the shape of a circular cylinder. The second body part 22 houses the motor 3 and at least a part of the transmission mechanism 41.

On a circumferential side surface of the second body part 22, provided are a plurality of projections 221. The plurality of projections 221 protrudes outward from the circumferential side surface of the second body part 22. The second body part 22 serves as a grip to be gripped by the user. In addition, the plurality of projections 221 also serves as an antislip portion when the user grips the second body part 22.

As shown in FIG. 1, the third body part 23 protrudes downward from the lower end of the second body part 22. The third body part 23 is formed in the shape of a circular cylinder. The third body part 23 houses at least a part of the transmission mechanism 41 and at least a part of the output shaft 42.

### (2.3) Coupling Shaft

As shown in FIG. 2, the coupling shaft 91 is a fastening member such as a screw. The coupling shaft 91 includes a head portion 911 and a shaft portion 912.

In front view, the head portion 911 according to the first embodiment has a circular shape. Alternatively, the head portion 911 may also have a polygonal shape in front view.

The shaft portion 912 according to the first embodiment protrudes forward from the center of the head portion 911. The shaft portion 912 according to the first embodiment is formed in the shape of a circular column extending in the forward/backward direction. A tip (front end) of the shaft portion 912 according to the first embodiment has a thread on the outer peripheral surface thereof. The shaft portion 912 is screwed into the hole 252 of the housing 2 after having penetrated through the through hole 254 of the housing 2 and a through hole 551 (to be described later) of the operating member 5.

The coupling shaft 91 is a member for coupling the housing 2 and the operating member 5 to each other. Removing the coupling shaft 91 from the housing 2 allows the operating member 5 to be removed from the housing 2.

### (2.4) Signal Connector

As shown in FIG. 1, the signal connector 74 is provided on the upper surface (of the first body part 21) of the housing 2. A signal cable is connected to the signal connector 74. The signal cable is a cable for use to connect the electric tool 1 to an external device. The electric tool 1 according to the first embodiment transmits and receives information about whether the fastening operation has been performed successfully or not to/from the external device via the signal cable. Note that the electric tool 1 does not have to include the signal connector 74. Alternatively, the electric tool 1 may also include a communications unit having the ability to communicate wirelessly with the external device instead of the signal connector 74.

### (2.5) Power Connector

As shown in FIG. 1, the power connector 75 is provided on the upper surface of the housing 2. The power connector 75 and the signal connector 74 are arranged side by side in the rightward/leftward direction. A power cable is connected to the power connector 75. The power cable is a cable for use to connect the electric tool 1 to an external power supply. The electric tool 1 according to the first embodiment is supplied with power from the external power supply via the power cable. Note that the electric tool 1 does not have to include the power connector 75. Alternatively, the electric tool 1 may include an attachment unit, to which a battery pack is attachable, instead of the power connector 75.

### (2.6) Motor

The motor 3 according to the first embodiment transforms the power supplied from the external power supply into rotational driving force. The motor 3 may be, for example, a brushless motor of an inner rotor type. The rotor of the motor 3 rotates around a rotary shaft parallel to the upward/downward direction. As shown in FIG. 3, the motor 3 according to the first embodiment has a through hole 31. The through hole 31 according to the first embodiment penetrates through a center axis of the motor 3 in the upward/downward direction. More specifically, the through hole 31 penetrates through a motor shaft of the motor 3 in the upward/downward direction.

### (2.7) Transmission Mechanism

As shown in FIG. 1, the transmission mechanism 41 is disposed under the motor 3 in an internal space (of the second body part 22) of the housing 2. The transmission mechanism 41 is a mechanism for transmitting the rotational driving force generated by the motor 3 to the output shaft 42. The transmission mechanism 41 according to the first embodiment includes a speed reducer mechanism and a clutch mechanism.

The speed reducer mechanism may be, for example, a planetary gear mechanism. The speed reducer mechanism transforms the rotational velocity and torque of the motor 3 into a rotational velocity and torque required to have the fastening operation done.

When the fastening torque becomes equal to or greater than a predetermined value, the clutch mechanism cuts off the transmission of the rotational driving force from the motor 3 to the output shaft 42. The clutch mechanism may be implemented as, for example, an electronic clutch.

Note that the transmission mechanism 41 does not have to include the speed reducer mechanism and the clutch mechanism. Optionally, the transmission mechanism 41 may include an impact mechanism for applying rotational impact to the output shaft 42.

### (2.8) Output Shaft

As shown in FIG. 1, the output shaft 42 is disposed under the transmission mechanism 41. The rotational driving force generated by the motor 3 is transmitted to the output shaft 42 via the transmission mechanism 41. Rotation of the rotor of the motor 3 causes the output shaft 42 to turn around the center axis Ax1.

The tip (lower end) of the output shaft 42 is configured such that the tip tool B1 such as a screwdriver bit is removably attached to the tip of the output shaft 42. For example, if a screwdriver bit is attached to the output shaft 42, rotating the screwdriver bit which is brought into contact with the fastening member (such as a screw) allows the operation of tightening or loosening the fastening member to be performed.

### (2.9) Holder

As shown in FIG. 1, the holder 43 is provided at the tip (lower end) of the output shaft 42. The holder 43 is a mechanism for holding the tip tool B1 with respect to the output shaft 42 in a situation where the tip tool B1 is attached to the output shaft 42.

### (2.10) Display Unit

As shown in FIG. 1, the display unit 71 is provided for the first surface 211 of the first body part 21 (of the housing 2). The display unit 71 according to the first embodiment is implemented as a two-digit seven-segment light-emitting diodes (LEDs). For example, the display unit 71 may indicate the number of fastening members that have been fastened using the electric tool 1.

### (2.11) Operating Unit

As shown in FIG. 1, the operating unit 72 is provided for the first surface 211 of the first body part 21 (of the housing 2). The operating unit 72 according to the first embodiment is implemented as three buttons 721. The electric tool 1 according to the first embodiment changes the operation mode in accordance with an operating command entered by the user using the three buttons 721.

The electric tool 1 according to the first embodiment operates in any of the three operation modes, namely, a first operation mode, a second operation mode, and a third operation mode, for example. As used herein, the first operation mode refers to an operation mode in which the output shaft 42 is caused to turn when the operating member 5 is operated by the user. The second mode herein refers to an operation mode in which the output shaft 42 is caused to turn when the tip tool B1 is pushed toward the motor 3 (i.e., pushed upward). The third mode herein refers to an operation mode in which the output shaft 42 is caused to turn either when the operating member 5 is operated by the user or when the tip tool B1 is pushed toward the motor 3. Note that the first mode is an operation mode in which the output shaft 42 is not caused to turn even when the tip tool B1 is pushed toward the motor 3. On the other hand, the second mode is an operation mode in which the output shaft 42 is not caused to turn even when the operating member 5 is operated by the user.

### (2.12) Forward/Reverse Switch

As shown in FIG. 1, the forward/reverse switch 73 is provided at an end (right end) of the first body part 21 (of the housing 2) in the rightward/leftward direction. The forward/reverse switch 73 is a switch for use to change the rotational direction of the output shaft 42 from a forward direction to a reverse (or backward) direction, or vice versa.

### (2.13) Operating Member

As shown in FIG. 1, the operating member 5 is provided at an end (left end) of the housing 2 in the rightward/leftward direction. As described above, the operating member 5 according to the first embodiment is attached to the housing 2 with the coupling shaft 91 (refer to FIG. 3). Removing the coupling shaft 91 from the housing 2 allows the operating member 5 to be removed from the housing 2. That is to say, the operating member 5 according to the first embodiment is configured to be removably attached to the housing 2. This allows, when the user uses the electric tool 1 in the second operation mode, for example, him or her to use the electric tool 1 with the operating member 5 removed from the housing 2, thus providing an electric tool 1 with improved user friendliness.

The operating member 5 according to the first embodiment is an operating lever. The operating member 5 is configured to be rotatable, around the shaft portion 912 of the coupling shaft 91, between the first position and the second position in accordance with the operation performed by the user. Specifically, unless the operating member 5 according to the first embodiment is subjected to a press operation by the user, the operating member 5 is located at the first position as shown in FIG. 3. On the other hand, when subjected to a press operation by the user, the operating member 5 according to the first embodiment rotates counterclockwise around the shaft portion 912 when viewed from in front of the operating member 5 in the forward direction to be displaced from the first position to the second position.

The operating member 5 includes a base portion 51, an edge portion 52, a first protruding portion 53, a second protruding portion 54, and an attaching portion 55.

The base portion 51 is formed in the shape of a flat plate. The base portion 51 according to the first embodiment faces a circumferential side surface of the housing 2 with a gap left in the rightward/leftward direction. As shown in FIG. 4, the thickness direction defined for the base portion 51 is aligned with the rightward/leftward direction when the operating member 5 is located at the second position. Note that in the first embodiment, the direction pointing from the base portion 51 toward the housing 2 in the rightward/leftward direction is defined to be a “rightward direction” and the direction pointing from the housing 2 toward the base portion 51 in the rightward/leftward direction is defined to be a “leftward direction.”

The edge portion 52 is provided at an edge of the base portion 51. The edge portion 52 protrudes from the base portion 51 toward the housing 2. The edge portion 52 protrudes rightward from the base portion 51 when the operating member 5 is located at the second position.

The attaching portion 55 protrudes in a predetermined direction from an upper end of the base portion 51. More specifically, the attaching portion 55 protrudes from the upper end of the base portion 51 toward the recess 25 (of the first body part 21) of the housing 2. The attaching portion 55 protrudes rightward from the upper end of the base portion 51 when the operating member 5 is located at the second position. As shown in FIG. 3, when the operating member 5 is located at the first position, the upper surface of the attaching portion 55 is in contact with the upper wall of the recess 25. In other words, a position where the upper surface of the attaching portion 55 is in contact with the upper wall of the recess 25 is the first position of the operating member 5.

The attaching portion 55 has a through hole 551. The through hole 551 penetrates through the attaching portion 55 in the forward/backward direction. The shaft portion 912 of the coupling shaft 91 is passed through the through hole 551.

The second protruding portion 54 is disposed under the attaching portion 55. More specifically, the second protruding portion 54 is disposed under the attaching portion 55 and over the first protruding portion 53. The second protruding portion 54 protrudes in a predetermined direction from the base portion 51. More specifically, the second protruding portion 54 is formed in the shape of a circular column that protrudes from the base portion 51 toward the through hole 24 of the housing 2. Even more specifically, the second protruding portion 54 is formed in the shape of a circular column, of which the protrusion height increases toward the lower end. When the operating member 5 is located at the second position, the second protruding portion 54 protrudes rightward from the base portion 51.

A tip surface (right surface) 541 of the second protruding portion 54 is circular in side view (i.e., when viewed in the rightward/leftward direction). The tip surface 541 according to the first embodiment faces upward to the right. The tip surface 541 is in contact with, and faces, a principal surface 621 of a cover portion 62 (to be described later) of the interlocking member 6 at both the first position and the second position. When displaced from the first position to the second position, the second protruding portion 54 (of the operating member 5) displaces the cover portion 62 in the direction in which the through hole 24 extends. In other words, displacement of the second protruding portion 54 from the first position to the second position causes the cover portion 62 to be displaced toward the inside of the housing 2 (i.e., to the right). This may simplify the configurations of the operating member 5 and the interlocking member 6 compared to a configuration in which the cover portion 62 is displaced toward the outside of the housing 2.

The first protruding portion 53 is disposed under the second protruding portion 54. More specifically, the first protruding portion 53 is disposed under the second protruding portion 54 and over the lower end of the edge portion 52. The first protruding portion 53 protrudes in a predetermined direction from the base portion 51. More specifically, the first protruding portion 53 is formed in the shape of a circular column that protrudes from the base portion 51 toward the second body part 22 of the housing 2. When the operating member 5 is located at the second position, the second protruding portion 54 protrudes to the right from the base portion 51. The second protruding portion 54 according to the first embodiment comes, when the operating member 5 is located at the second position, into contact with at least one of the circumferential side surface or the projections 221 of the second body part 22 of the housing 2. In other words, the position where the second protruding portion 54 comes into contact with at least one of the circumferential side surface or the projections 221 of the second body part 22 is the second position of the operating member 5.

### (2.14) Interlocking Member

The interlocking member 6 according to the first embodiment is a lever member which is interlocked with the operating member 5. As shown in FIGS. 3 and 4, at least part of the interlocking member 6 is housed inside (the first body part 21 of) the housing 2. As described above, as the operating member 5 is displaced, the interlocking member 6 is displaced between the third position (refer to FIG. 3) and the fourth position (refer to FIG. 4). Specifically, the interlocking member 6 is located at the third position when the operating member 5 is located at the first position and is located at the fourth position when the operating member 5 is located at the second position.

The interlocking member 6 according to the first embodiment is disposed at an end (i.e., left end) inside the housing 2 in the rightward/leftward direction. The interlocking member 6 is formed in the shape of a curved plate. The interlocking member 6 includes a bent portion 61, the cover portion 62, an extended portion 63, a tip portion 64, a protruding portion 65, and a magnet 66.

The bent portion 61 is formed in the shape of a U-curved plate. The bent portion 61 according to the first embodiment is bent to be convex away from the operating member 5 (i.e., to the right). The bent portion 61 is bent to conform with the shape of the bottom wall 250 of the recess 25 of the housing 2.

The cover portion 62 protrudes downward to the right from the lower end of the bent portion 61. The cover portion 62 is arranged to close the through hole 24 of the housing 2. More specifically, the cover portion 62 is arranged to close the through hole 24 of the housing 2 when the interlocking member 6 is located at the third position. Arranging the cover portion 62 to close the through hole 24 of the housing 2 reduces the chances of sand, dust, and other foreign particles entering the housing 2.

As described above, displacement (of the second protruding portion 54) of the operating member 5 from the first position to the second position causes the cover portion 62 to be displaced toward the inside of the housing 2. Having the cover portion 62 pushed by the second protruding portion 54 of the operating member 5 causes the interlocking member 6 to be displaced from the third position to the fourth position.

The cover portion 62 has the principal surface 621 and a through hole 622.

The through hole 622 penetrates through the cover portion 62 in the forward/backward direction. A coupling shaft 92 is passed through the through hole 622. The coupling shaft 92 is a circular columnar shaft extending in the forward/backward direction. The coupling shaft 92 is fixed to the housing 2 when passed through the through hole 622. In other words, the interlocking member 6 is mounted to the housing 2 via the coupling shaft 92. The interlocking member 6 is configured to be rotatable, around the coupling shaft 92 (as a rotary shaft), between the third position and the fourth position. More specifically, when the operating member 5 is subjected to a press operation by the user, the interlocking member 6 turns counterclockwise around the rotary shaft when viewed from in front of the interlocking member 6 to be displaced from the third position to the fourth position. Adopting such a configuration in which the interlocking member 6 is displaced in a rotational direction around the rotary shaft may be simpler than a configuration in which the interlocking member 6 is displaced to be translated, for example.

The principal surface 621 of the cover portion 62 is a surface facing the outside of the housing 2. The principal surface 621 is surrounded with an inner circumferential surface that forms the through hole 24 of the housing 2. The principal surface 621 of the cover portion 62 is arranged to be flush with the surface (i.e., circumferential side surface) of the housing 2 when the cover portion 62 (of the interlocking member 6) is located at the third position. Making the principal surface 621 of the cover portion 62 flush with the surface of the housing 2 reduces the chances of the electric tool 1 being activated erroneously even when the user happens to put his or her fingers on the principal surface 621 of the cover portion 62 with the operating member 5 removed from the housing 2, for example.

As used herein, if something is “flush with” something else, then the two things do not have to form exactly the same plane but may also form substantially the same plane (i.e., may also be substantially flush with each other). For example, if A and B are herein referred to as being flush with each other, A and B do not have to form exactly the same plane. That is to say, if A and B are herein referred to as being flush with each other, then A and B may form substantially the same plane. Specifically, A may slightly protrude (i.e., may be slightly raised) with respect to B or may be slightly depressed with respect to B. For example, the principal surface 621 of the cover portion 62 may be slightly depressed with respect to the surface of the housing 2.

The extended portion 63 protrudes upward from the upper end of the bent portion 61. The extended portion 63 is formed in the shape of a flat plate. When the interlocking member 6 is located at the fourth position, the thickness direction defined for the extended portion 63 is parallel to the rightward/leftward direction.

The tip portion 64 protrudes upward from the upper end of the extended portion 63. The tip portion 64 is formed in the shape of a flat plate. When the interlocking member 6 is located at the fourth position, the thickness direction defined for the tip portion 64 is parallel to the rightward/leftward direction. The tip portion 64 is thicker than the extended portion 63. The tip portion 64 holds the magnet 66.

The magnet 66 is a permanent magnet such as a neodymium magnet, a ferrite magnet, or a plastic magnet. The magnet 66 is arranged to face the first switch unit 8 in the rightward/leftward direction when the interlocking member 6 is located at the fourth position. More specifically, the magnet 66 is arranged to face the first switch unit 8 with a very narrow gap left between themselves when the interlocking member 6 is located at the fourth position. The magnet 66 is held (arranged) to be out of contact with the first switch unit 8, thus reducing the chances of either the magnet 66 or the tip portion 64 coming into contact with the first switch unit 8 to cause a failure to any constituent member of the first switch unit 8.

The protruding portion 65 protrudes to the left from the extended portion 63. The protruding portion 65 is formed in the shape of a circular column. An elastic member 9 such as a coil spring is wound around the circumferential side surface of the protruding portion 65 according to the first embodiment.

### (2.15) Elastic Member

As shown in FIGS. 3 and 4, the elastic member 9 according to the first embodiment is a helical spring. As described above, the elastic member 9 is wound around the protruding portion 65 of the interlocking member 6. The right end of the elastic member 9 is in contact with the extended portion 63 of the interlocking member 6. The left end of the elastic member 9 is in contact with (the first body part 21 of) the housing 2.

The elastic member 9 applies (elastic) force to the interlocking member 6 such that the interlocking member 6 is located at the third position unless the operating member 5 is subjected to a press operation by the user (i.e., when the operating member 5 is located at the first position or if the operating member 5 is removed from the housing 2). In other words, the elastic member 9 applies force to the extended portion 63 of the interlocking member 6 to make the principal surface 621 of the cover portion 62 flush with the surface (circumferential side surface) of the housing 2 unless the operating member 5 is subjected to a press operation by the user. Making the principal surface 621 of the cover portion 62 flush with the surface of the housing 2 using the elastic force applied by the elastic member 9 enables keeping the principal surface 621 of the cover portion 62 and the surface of the housing 2 flush with each other.

### (2.16) First Switch Unit

As shown in FIGS. 3 and 4, the first switch unit 8 according to the first embodiment is arranged to face the magnet 66 of the interlocking member 6 when the interlocking member 6 is located at the fourth position.

The first switch unit 8 according to the first embodiment includes a magnetic sensor for detecting the magnetism produced by the magnet 66. The first switch unit 8 selectively provides or cuts off the supply of power from an external power supply to the motor 3 in response to detection of magnetism by the magnetic sensor. The supply of the power to the motor 3 may be provided or cut off without bringing the interlocking member 6 into contact with the first switch unit 8, thus reducing the chances of the magnetic sensor of the first switch unit 8 going out of order. Note that the first switch unit 8 selectively provides or cuts off the supply of the power from the external power supply to the motor 3 by selectively electrically connecting or disconnecting the power connector 75 to/from the motor 3.

The first switch unit 8 cuts off the supply of the power from the external power supply to the motor 3 when the distance between the first switch unit 8 and the magnet 66 is equal to or greater than a first threshold value. The first switch unit 8 provides the supply of the power from the external power supply to the motor 3 when the distance between the first switch unit 8 and the magnet 66 is less than the first threshold value. In the first embodiment, if the interlocking member 6 is located at the third position, the distance between the first switch unit 8 and the magnet 66 is equal to or greater than the first threshold value. On the other hand, in the first embodiment, if the interlocking member 6 is located at the fourth position, the distance between the first switch unit 8 and the magnet 66 is less than the first threshold value. Thus, the first switch unit 8 cuts off the supply of the power to the motor 3 when the interlocking member 6 is located at the third position and provides the supply of the power to the motor 3 when the interlocking member 6 is located at the fourth position.

### (2.17) Second Switch Unit

As shown in FIGS. 3 and 4, the second switch unit 10 is disposed over the motor 3. The second switch unit 10 provides the supply of the power to the motor 3 when the tip tool B1 is displaced toward the motor 3 (i.e., displaced upward). Note that the second switch unit 10 selectively provides or cuts off the supply of the power from the external power supply to the motor 3 by selectively electrically connecting or disconnecting the power connector 75 to/from the motor 3.

The electric tool 1 according to the first embodiment further includes a holder 11, a magnet 12, and a drive shaft 13.

The holder 11 is disposed over the motor 3. The holder 11 holds the magnet 12. More specifically, the holder 11 holds the magnet 12 such that the magnet 12 faces the second switch unit 10 in the upward/downward direction. The holder 11 has a recess 111. The recess 111 is provided on the lower surface of the holder 11. The recess 111 is depressed upward.

The drive shaft 13 is a shaft that passes through the through hole 31 of the motor 3. The drive shaft 13 is located under the holder 11 and over the output shaft 42 (refer to FIG. 1).

When the tip tool B1 (on the output shaft 42) is pushed toward the motor 3 (i.e., pushed upward), the drive shaft 13 is displaced toward the holder 11 (i.e., upward). As the drive shaft 13 is displaced upward, the upper end of the drive shaft 13 is inserted into the recess 111 of the holder 11. Furthermore, the upward displacement of the drive shaft 13 causes the drive shaft 13 to displace the holder 11 upward. That is to say, as the tip tool BI is pushed by the user toward the motor 3, the magnet 12 held by the holder 11 is brought closer toward the second switch unit 10.

The second switch unit 10 includes a magnetic sensor for detecting the magnetism produced by the magnet 12. The second switch unit 10 selectively provides or cuts off the supply of power to the motor 3 in response to detection of the magnetism by the magnetic sensor. Specifically, the second switch unit 10 cuts off the supply of the power to the motor 3 when the distance between the second switch unit 10 and the magnet 12 is equal to or greater than a second threshold value and provides the supply of the power to the motor 3 when the distance between the second switch unit 10 and the magnet 12 is less than the second threshold value. The second switch unit 10 provides the supply of the power to the motor 3 when the tip tool B1 is pressed by the user toward the motor 3 to make the distance between the second switch unit 10 and the magnet 12 less than the second threshold value.

This electric tool 1 according to the first embodiment allows the tip tool B1 to be turned by two different operating methods, thus providing an electric tool 1 with improved user friendliness. In addition, this also allows the electric tool 1 to be used even when the operating member 5 is removed from the housing 2.

### (3) Variations

Next, variations of the first embodiment will be enumerated one after another. Note that the variations to be described below may be adopted in combination as appropriate.

In the first embodiment described above, the operating member 5 and the interlocking member 6 are provided separately from each other as an example. Alternatively, the operating member 5 and the interlocking member 6 may be formed integrally with each other.

Alternatively, the operating member 5 may also be configured to turn, when subjected to a press operation by the user, clockwise around the shaft portion 912 in front view to be displaced from the first position to the second position. Still alternatively, the operating member 5 may also be configured to be translated, when subjected to a press operation by the user, in the rightward/leftward direction, for example, to be displaced from the first position to the second position. Yet alternatively, the interlocking member 6 may also be configured to turn, when the operating member 5 is subjected to a press operation by the user, clockwise around the shaft portion 912 (rotary shaft) in front view to be displaced from the third position to the fourth position. Still alternatively, the interlocking member 6 may also be configured to be translated, when the operating member 5 is subjected to a press operation by the user, in the rightward/leftward direction, for example, to be displaced from the third position to the fourth position.

In the first embodiment described above, the distance between the magnet 66 and the first switch unit 8 when the interlocking member 6 is located at the third position is supposed to be longer than the distance between the magnet 66 and the first switch unit 8 when the interlocking member 6 is located at the fourth position as an example. Alternatively, the distance between the magnet 66 (at the tip portion 64) and the first switch unit 8 when the interlocking member 6 is located at the third position may also be shorter than the distance between the magnet 66 and the first switch unit 8 when the interlocking member 6 is located at the fourth position. In that case, the first switch unit 8 cuts off the supply of power to the motor 3 when the distance between the first switch unit 8 and the magnet 66 is less than a first threshold value and provides the supply of power to the motor 3 when the distance between the first switch unit 8 and the magnet 66 is equal to or greater than the first threshold value.

### Second Embodiment

An electric tool 1 according to a second embodiment includes a first switch unit 8a instead of the first switch unit 8, which is a difference from the electric tool 1 according to the first embodiment described above.

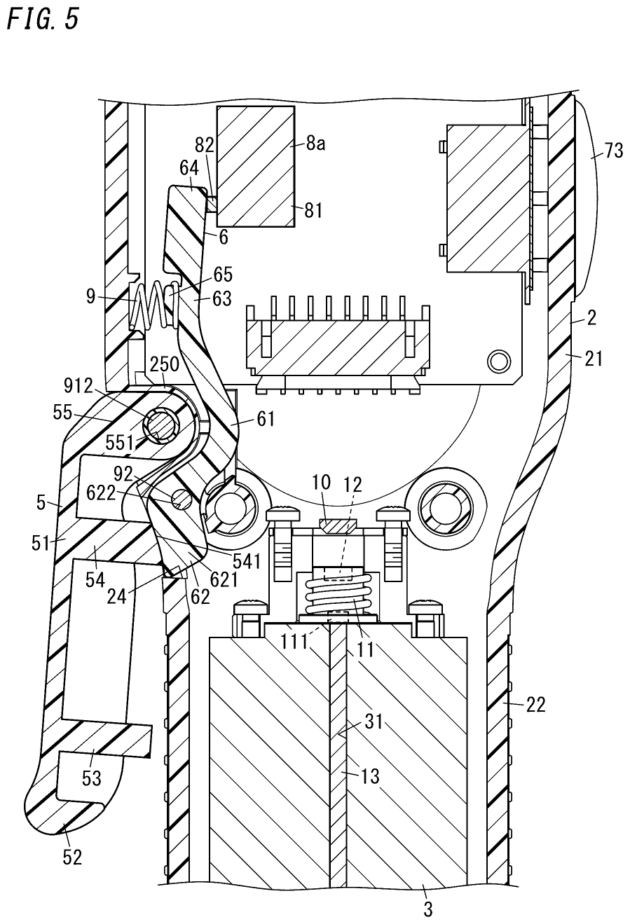

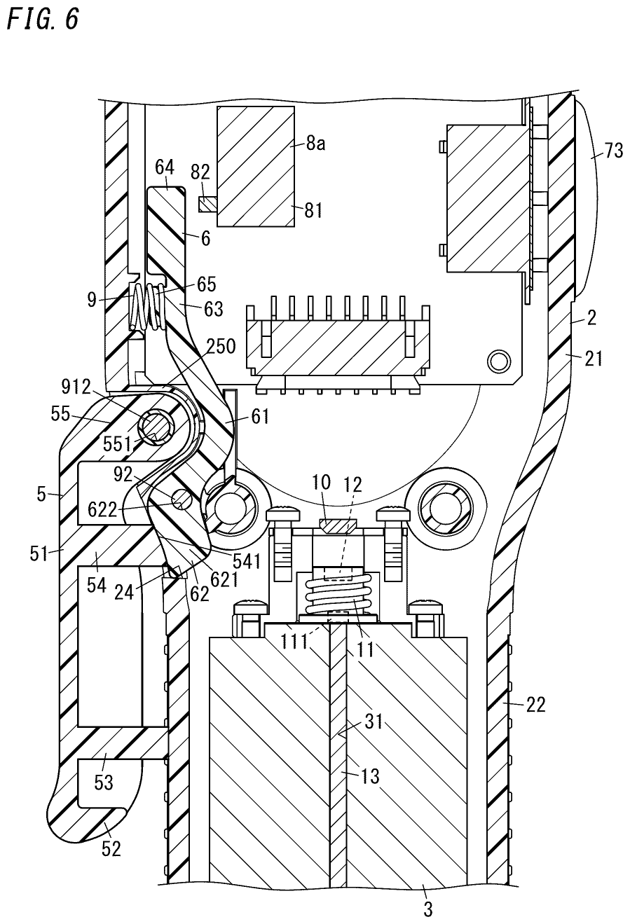

As shown in FIGS. 5 and 6, the first switch unit 8a according to the second embodiment is disposed on the right of the tip portion 64 of the interlocking member 6.

The first switch unit 8a selectively provides or cuts off the supply of power from the external power supply to the motor 3 by mechanically turning a micro switch or a limit switch, for example. The first switch unit 8a includes a body 81 and a displaceable portion 82.

The body 81 may be formed, for example, in a rectangular parallelepiped shape. The body 81 may be mounted, for example, on a board housed in the first body part 21 of the housing 2.

The displaceable portion 82 according to the second embodiment may be, for example, a push button. The displaceable portion 82 protrudes to the left from a left surface of the body 81. The displaceable portion 82 may be formed in the shape of a circular column, for example. The displaceable portion 82 is displaced between a fifth position (refer to FIG. 5) and a sixth position (refer to FIG. 6). The displaceable portion 82 according to the second embodiment is displaced between the fifth position and the sixth position by being translated in the rightward/leftward direction.

The fifth position as used herein includes the position of the displaceable portion 82 when the interlocking member 6 is located at the third position and the position of the displaceable portion 82 when the supply of the power to the motor 3 is cut off. The sixth position as used herein includes the position of the displaceable portion 82 when the interlocking member 6 is located at the fourth position and the position of the displaceable portion 82 when the supply of the power to the motor 3 is provided.

The first switch unit 8a according to the second embodiment cuts off the supply of the power from the external power supply to the motor 3 when the displaceable portion 82 is located at the fifth position and provides the supply of the power from the external power supply to the motor 3 when the displaceable portion 82 is located at the sixth position. In other words, the first switch unit 8a according to the second embodiment cuts off the supply of the power from the external power supply to the motor 3 when the displaceable portion 82 is pushed toward the body 81 and provides the supply of the power from the external power supply to the motor 3 when the displaceable portion 82 is not pushed toward the body 81.

As shown in FIG. 5, when the interlocking member 6 is located at the third position, the tip portion 64 of the interlocking member 6 pushes the displaceable portion 82 of the first switch unit 8a toward the body 81 to displace the displaceable portion 82 to the fifth position. On the other hand, as shown in FIG. 6, when the interlocking member 6 is located at the fourth position, the tip portion 64 of the interlocking member 6 is out of contact with the displaceable portion 82 of the first switch unit 8a. When the tip portion 64 of the interlocking member 6 is out of contact with the displaceable portion 82 of the first switch unit 8a, the displaceable portion 82 is located at the sixth position. In other words, when the interlocking member 6 is located at the fourth position, the tip portion 64 of the interlocking member 6 displaces the displaceable portion 82 to the sixth position.

The electric tool 1 according to the second embodiment uses a relatively inexpensive switch such as a micro switch as the first switch unit 8a, thus achieving the advantage of cutting down the manufacturing cost.

Next, variations of the second embodiment will be enumerated one after another. Note that the variations to be described below may be adopted in combination as appropriate.

The first switch unit 8a may provide the supply of power to the motor 3 when the displaceable portion 82 is pushed toward the body 81 and may cut off the supply of the power to the motor 3 when the displaceable portion 82 is not pushed toward the body 81. In that case, the tip portion 64 of the interlocking member 6 is out of contact with the displaceable portion 82 of the first switch unit 8a when the interlocking member 6 is located at the third position and pushes the displaceable portion 82 toward the body 81 when the interlocking member 6 is located at the fourth position.

Optionally, the displaceable portion 82 of the first switch unit 8a may also be configured to be displaced between the fifth position and the sixth position by either being translated in the upward/downward direction or the forward/backward direction or moving rotationally.

### Recapitulation

As can be seen from the foregoing description of embodiments, an electric tool (1) according to a first aspect includes a motor (3), a switch unit (first switch unit 8; first switch unit 8a), a housing (2), an operating member (5), and an interlocking member (6). The motor (3) rotates a tip tool (B1). The switch unit selectively provides or cuts off supply of power to the motor (3). The housing (2) houses the motor (3). The operating member (5) is provided outside the housing (2) and is displaced between a first position and a second position in response to an operation. The interlocking member (6) is displaced between a third position and a fourth position in response to displacement of the operating member (5). The housing (2) is arranged to house the switch unit. The switch unit cuts off the supply of the power to the motor (3) when the interlocking member (6) is located at the third position and provides the supply of the power to the motor (3) when the interlocking member (6) is located at the fourth position.

According to this aspect, the switch unit (first switch unit 8: first switch unit 8a) is provided inside the housing (2), thus reducing the chances of impact being applied to the switch unit compared to a situation where the switch unit is exposed outside the housing (2). Consequently, this may reduce the chances of a constituent member such as a switch unit going out of order.

In an electric tool (1) according to a second aspect, which may be implemented in conjunction with the first aspect, the housing has a through hole (24). The through hole (24) is arranged to face the operating member (5). The interlocking member (6) includes a cover portion (62). The cover portion (62) is arranged to close the through hole (24). The operating member (5) displaces, when displaced from the first position to the second position, the cover portion (62) in a direction in which the through hole (24) extends. The interlocking member (6) is displaced, when the cover portion (62) is displaced by the operating member (5), from the third position to the fourth position.

According to this aspect, the cover portion (62) is arranged to close the through hole (24) of the housing (2), thus reducing the chances of sand, dust, and other foreign particles entering the housing (2).

In an electric tool (1) according to a third aspect, which may be implemented in conjunction with the second aspect, the operating member (5) displaces, when displaced from the first position to the second position, the cover portion (62) toward inside of the housing (2).

This aspect enables simplifying the configurations of the operating member (5) and the interlocking member (6) compared to a configuration in which the cover portion (62) is displaced toward the outside of the housing (2).

In an electric tool (1) according to a fourth aspect, which may be implemented in conjunction with the second or third aspect, the cover portion (62) has a principal surface (621) which is flush with a surface of the housing (2) when the interlocking member (6) is located at the third position.

According to this aspect, the principal surface (621) of the cover portion (62) is flush with the surface of the housing (2), thus reducing the chances of the electric tool (1) being activated erroneously even when the user happens to put his or her fingers on the principal surface (621) with the operating member (5) removed from the housing (2), for example.

An electric tool (1) according to a fifth aspect, which may be implemented in conjunction with any one of the second to fourth aspects, further includes an elastic member (9). The elastic member (9) applies force to the interlocking member (6) to make a principal surface (621) of the cover portion (62) flush with a surface of the housing (2) unless the operating member (5) is operated.

This aspect allows the elastic member (9) to apply force that makes the principal surface (621) of the cover portion (62) flush with the surface of the housing (2), thus enabling keeping the principal surface (621) of the cover portion (62) flush with the surface of the housing (2).

In an electric tool (1) according to a sixth aspect, which may be implemented in conjunction with any one of the first to fifth aspects, the operating member (5) is provided removably with respect to the housing (2).

This aspect allows, if the electric tool (1) is designed to operate when a tip tool (B1) is pushed into the electric tool (1), for example, the user to use the electric tool (1) with the operating member (5) removed from the housing (2), thus providing an electric tool (1) with improved user friendliness.

In an electric tool (1) according to a seventh aspect, which may be implemented in conjunction with any one of the first to sixth aspects, the interlocking member (6) includes a magnet (66). The switch unit (first switch unit 8) includes a magnetic sensor for detecting magnetism produced by the magnet (66). The switch unit selectively provides or cuts off the supply of the power to the motor (3) in response to detection of the magnetism by the magnetic sensor.

This aspect may selectively provide or cut off the supply of the power to the motor (3) without bringing the interlocking member (6) into contact with the switch unit (first switch unit 8), thus reducing the chances of a constituent member of the switch unit going out of order.

In an electric tool (1) according to an eighth aspect, which may be implemented in conjunction with any one of the first to sixth aspects, the switch unit (first switch unit 8a) includes a displaceable portion (82) to be displaced between a fifth position and a sixth position. The switch unit cuts off the supply of the power to the motor (3) when the displaceable portion (82) is located at the fifth position and provides the supply of the power to the motor (3) when the displaceable portion (82) is located at the sixth position. The interlocking member (6) causes, when located at the third position, the displaceable portion (82) of the switch unit to be displaced to the fifth position, and causes, when located at the fourth position, the displaceable portion (82) of the switch unit to be displaced to the sixth position.

This aspect achieves the advantage of cutting down the manufacturing cost by using a relatively inexpensive switch such as a micro switch as the switch unit (first switch unit 8a).

In an electric tool (1) according to a ninth aspect, which may be implemented in conjunction with any one of the first to eighth aspects, the interlocking member (6) is configured to be rotatable, around a rotary shaft (coupling shaft 92), between the third position and the fourth position.

This aspect may simplify the configuration by making the interlocking member (6) displaceable in a rotational direction around the rotary shaft (coupling shaft 92), compared to a configuration in which the interlocking member (6) is displaced to be translated, for example.

An electric tool (1) according to a tenth aspect, which may be implemented in conjunction with any one of the first to ninth aspects, further includes a second switch unit (10) provided separately from a first switch unit (8; 8a) serving as the switch unit. The second switch unit (10) provides, when the tip tool (B1) is displaced toward the motor (3), the supply of the power to the motor (3).

This aspect allows the tip tool (B1) to be turned by two different operating methods, thus providing an electric tool (2) with improved user friendliness. In addition, this aspect also allows the electric tool (1) to be used even when the operating member (5) is removed from the housing (2).

Note that the constituent elements according to the second to tenth aspects are not essential constituent elements for the electric tool (1) but may be omitted as appropriate.

### Reference Signs List

1 Electric Tool
2 Housing
24 Through Hole
3 Motor
5 Operating Member
6 Interlocking Member
62 Cover Portion
66 Magnet
621 Principal Surface
8, 8a First Switch Unit (Switch Unit)
82 Displaceable Portion
9 Elastic Member
92 Coupling Shaft (Rotary Shaft)
10 Second Switch Unit
B1 Tip Tool

1. An electric tool comprising:
a motor configured to rotate a tip tool;
a switch unit configured to selectively provide or cut off supply of power to the motor;
a housing that houses the motor;
an operating member provided outside the housing and configured to be displaced between a first position and a second position in response to an operation; and
an interlocking member configured to be displaced between a third position and a fourth position in response to displacement of the operating member,
the housing being arranged to house the switch unit, and
the switch unit being configured to cut off the supply of the power to the motor when the interlocking member is located at the third position and provide the supply of the power to the motor when the interlocking member is located at the fourth position.

2. The electric tool of claim 1, wherein
the housing has a through hole,
the through hole is arranged to face the operating member,
the interlocking member includes a cover portion,
the cover portion is arranged to close the through hole,
the operating member is configured to, when displaced from the first position to the second position, displace the cover portion in a direction in which the through hole extends, and
the interlocking member is configured to, when the cover portion is displaced by the operating member, be displaced from the third position to the fourth position.

3. The electric tool of claim 2, wherein
the operating member is configured to, when displaced from the first position to the second position, displace the cover portion toward inside of the housing.

4. The electric tool of claim 2, wherein
the cover portion has a principal surface which is flush with a surface of the housing when the interlocking member is located at the third position.

5. The electric tool of claim 2, further comprising an elastic member configured to apply force to the interlocking member to make a principal surface of the cover portion flush with a surface of the housing unless the operating member is operated.

6. The electric tool of claim 1, wherein
the operating member is provided removably with respect to the housing.

7. The electric tool of claim 1, wherein
the interlocking member includes a magnet, and
the switch unit includes a magnetic sensor configured to detect magnetism produced by the magnet, and
the switch unit is configured to selectively provide or cut off the supply of the power to the motor in response to detection of the magnetism by the magnetic sensor.

8. The electric tool of claim 1, wherein
the switch unit includes a displaceable portion configured to be displaced between a fifth position and a sixth position,
the switch unit is configured to cut off the supply of the power to the motor when the displaceable portion is located at the fifth position and provide the supply of the power to the motor when the displaceable portion is located at the sixth position, and
the interlocking member is configured to, when located at the third position, cause the displaceable portion of the switch unit to be displaced to the fifth position, and when located at the fourth position, cause the displaceable portion of the switch unit to be displaced to the sixth position.

9. The electric tool of claim 1, wherein
the interlocking member is configured to be rotatable, around a rotary shaft, between the third position and the fourth position.

10. The electric tool of claim 1, further comprising a second switch unit provided separately from a first switch unit serving as the switch unit, wherein
the second switch unit is configured to, when the tip tool is displaced toward the motor, provide the supply of the power to the motor.
